(19) United States
(12) Patent Application Publication
(10) Pub. No.: US 2011/0032391 A1
(43) Pub. Date: Feb. 10, 2011

(54) Image Sensor with Peripheral Dummy Pixels

(75) Inventor: DESMOND CHEUNG, TAINAN (TW)

Correspondence Address: STOUT, UXA, BUYAN & MULLINS LLP, 4 VENTURE, SUITE 300, IRVINE, CA, 92618, US

(73) Assignee: HIMAX IMAGING, INC., Grand Cayman (KY)

(21) Appl. No.: 12/535,663

(22) Filed: Aug. 4, 2009

(51) Int. Cl. H04N 5/217; H04N 5/335

(52) U.S. Cl. 348/241; 348/308; 348/E05.079; 348/E05.091

(57) ABSTRACT

An image sensor with an active pixel array and peripheral dummy pixels is disclosed. The dummy pixels are located between (a) at least a portion of the active pixel array and (b) undesired or potentially interfering noise from a noise source. Outputs of the dummy pixels are coupled to float with respect to the active pixel array, thereby blocking the noise from being coupled into the active pixel array.

### BACKGROUND OF THE INVENTION

1. Field of the Invention

The present invention generally relates to an image sensor, and more particularly to an image sensor with an active pixel array surrounded by peripheral dummy pixels.

2. Description of the Prior Art

Semiconductor based image sensors, such as charge-coupled devices (CCDs) or complementary metal-oxide-semiconductor (CMOS) image sensors, are widely used in, for example, cameras or camcorders, to convert images of visible light into electronic signals that may be stored, transmitted or displayed thereafter.

The image sensor is generally a mixed-signal system having both analog circuits and digital circuits on a single device. Noise is commonly present in the analog/digital circuits of the image sensor, which noise often may propagate from the analog/digital circuits and disadvantageously affect the imaging area of the image sensor. Another noise source outside of the imaging area is the dark reference pixel array used for obtaining a black level reference. The undesired noise often may be coupled to the imaging area, for example, through the substrate, causing interference. As a result, the performance of the image sensor, for example, measured by a signal-to-noise ratio, can suffer greatly. The effect caused by this interfering or potentially interfering noise becomes more severe when the image sensor employs active pixel sensor (APS) structure in which each pixel contains its own active amplifier.

For the reason that conventional image sensors cannot effectively defend against noise, a need has arisen to propose a novel technique for minimizing an influence of noise on the imaging area (e.g., the active pixel array) of the image sensor.

### SUMMARY OF THE INVENTION

In view of the foregoing, it is an object of the present invention to provide a scheme to block undesired or potentially interfering noise, originating externally in analog/digital circuitry and/or a dark reference pixel array, from being coupled into the imaging area.

According to one embodiment, an imaging pixel array is surrounded by a ring of non-imaging pixels. External to the ring of non-imaging pixels is a noise source, such as an analog circuit, a digital circuit, or a dark reference pixel array. The embodiment causes unwanted charge originating from the noise source to be drained away by the non-imaging pixels.

According to another embodiment, a dark reference pixel array containing light-shielded pixels is enclosed and protected by the ring of non-imaging pixels.

### BRIEF DESCRIPTION OF THE DRAWINGS

FIG. 1 shows an overview of the layout of a CMOS image sensor (CIS) according to one embodiment of the present invention;

FIG. 2 shows exemplary circuitry constituting an active pixel and a nearby dummy pixel according to one embodiment of the present invention; and

FIG. 3 shows an overview of the layout of a CMOS image sensor (CIS) according to a further embodiment of the present invention.

### DETAILED DESCRIPTION OF THE INVENTION

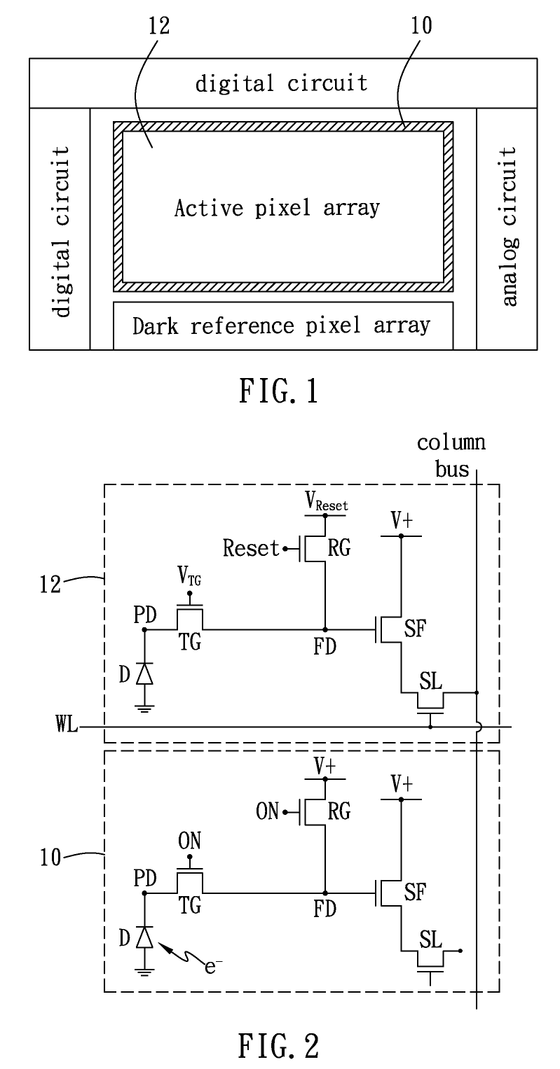

FIG. 1 shows an overview of the layout of a CMOS image sensor (CIS) according to one embodiment of the present invention. Although the CIS is discussed in the exemplary embodiment, the present invention may be well adapted to other image sensors. In the embodiment, the image sensor includes a ring of dummy pixels 10 that surround the active pixel array of an imaging area 12 containing an active pixel array. As used herein, the term “active” pixel denotes an imaging pixel in opposition to the term “dummy” pixel that denotes a non-imaging pixel. Accordingly, the active pixel array in the imaging area 12 may constitute the active pixel sensor (APS) or the passive pixel sensor (PPS). It is appreciated that the shape of the (peripheral) dummy pixel ring 10 may not necessarily be rectangular, and the dummy pixel ring 10 may not necessarily be a closed ring or a loop. Further, there may be more than one dummy pixel ring 10 that are either unconnected or connected.

External to the dummy pixels 10 may, but need not necessarily, be, disposed one or more of an analog circuit, a digital circuit, and/or a dark reference pixel array. The analog circuit(s), digital circuit(s), and/or dark reference pixel array constitutes a noise source that generates undesired or potentially interfering noise in the form of, for example, charge. The noise source is not limited to those mentioned, and, in general, may be any circuit, such as a power circuit, that generates and propagates noise to affect the active pixel 12.

FIG. 2 shows exemplary circuitry constituting an active pixel 12 and a nearby dummy pixel 10 according to one embodiment of the present invention. In the embodiment, the active pixel 12 contains a photodiode D and four transistors—a transfer gate TG, a reset gate RG, a source follower SF, and a selector SL. The active pixel 12 is commonly known as 4T pixel circuit of the CMOS image sensor. Although the 4T pixel circuit is illustrated in the present embodiment, it is appreciated by those skilled in the pertinent art that many different variations of the structure of the pixel circuit may be used. For example, a 3T pixel circuit, 5T pixel circuit, 6T pixel circuit, etc. may be well adapted to the present invention.

Regarding the active pixel 12, in the present embodiment, the transfer gate TG, controlled under a transfer signal V_{TG}, is used to controllably transfer the integrated light signal at the node PD of the photodiode D. The reset gate RG, when it is turned on by a reset signal (Reset), is used to reset the photodiode D to a reset reference voltage V_{Reset}. The output of the transfer gate TG and the output of the reset gate RG are connected together to the floating diffusion (FD) node FD, which is further connected to the gate of the source follower SF, which is utilized to buffer or amplify the integrated light signal of the photodiode D. The output of the source follower SF may be read through a column bus (or a bit line) via a selector SL, when it is turned on by a word line signal WL.

The dummy pixel 10 in the embodiment contains a photodiode D, a transfer gate TG, a reset gate RG, a source follower SF, and a selector SL configured in a way similar to that in the active pixel 12, although they may not necessarily have to be similar to each other. The output of the dummy pixel 10 is floating. Specifically, the selector SL, in the present embodiment, is not connected to the column bus, but is floating. Moreover, the transfer gate TG is always turned on, for example, by connecting its gate to a high voltage ON. The reset gate RG is always turned on, for example, by connecting its gate to a high voltage ON, and its drain is connected to a high voltage V+ in order to constantly reset the photodiode D. As a result, any unwanted collected charge (e⁻) originating from one or more of the analog circuit, the digital circuit, and the dark reference pixel array (FIG. 1) may be drained away, particularly collected by the photodiode D. Therefore, the charge (e⁻) will not be collected by the active pixel 12. As the output of the source follower SF is floating, the collected charge (e⁻) will not be read through the column bus, and will be eventually discarded. Although a type of photodiode D that collects electrons is illustrated here, it is known that there is also a type of photodiode that collects holes instead. The dummy pixels accordingly will drain holes away rather than electrons. In particular or modified embodiments, the dummy pixels 10 may be unconnected or connected, in whole or in part, amongst themselves.

It is appreciated by those skilled in the pertinent art that the active pixel 12 and the dummy pixel 10 may not necessarily be on the same level in the image sensor. Generally speaking, the undesired noise may be substantially reduced or blocked provided that, by way of example and not limitation, the dummy pixels 10 are located between at least a portion of the active pixel array 12 and the noise source or sources.

According to the embodiments disclosed above, the noise from outside analog/digital circuits and/or a dark reference pixel array may be blocked from being coupled into the imaging area 12. The signal-to-noise ratio may accordingly be substantially increased, and the performance of the image sensor may thus be improved.

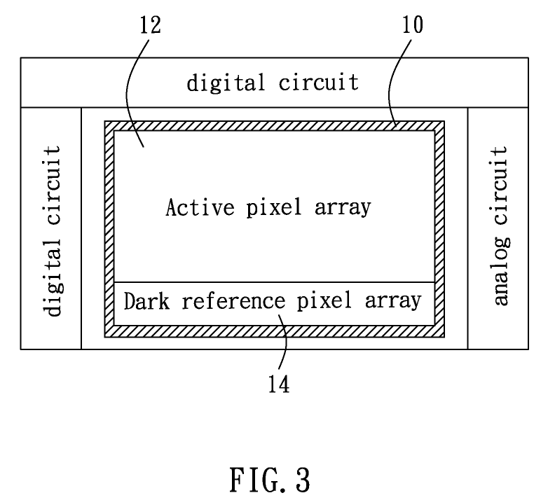

FIG. 3 shows an overview of the layout of a CMOS image sensor (CIS) according to a further embodiment of the present invention. In the embodiment, a dark reference pixel array 14 is enclosed by the dummy pixel ring 10. The dark reference pixel array 14 may contain one or more light-shielded pixel or optical black pixel. In practice, the dark reference pixel array 14 typically contains multiple rows of light-shielded pixels. In a black level calibration (BLC) phase, dark signal of these light-shielded pixels is collected as a black level reference (or dark reference), which is then, for example, subtracted from the effective image signal integrated from the active pixel array 12, therefore improving the image quality.

According to this embodiment, in addition to the active pixel array 12, the dark reference pixel array 14 is also significantly protected (by the dummy pixel ring 10) from being affected by undesired noise from the noise source such as the analog/digital circuit, even though the pixels of the dark reference pixel array 14 are not effective pixels for the purpose of imaging. Under usual conditions, the dark reference pixel array 14 generates less noise than the analog/digital circuit external to the dummy pixel ring 10.

Although specific embodiments have been illustrated and described, it will be appreciated by those skilled in the art that various modifications may be made without departing from the scope of the present invention, which is intended to be limited solely by the appended claims.

What is claimed is:

1. An image sensor comprising:
an active pixel array located in an imaging area; and
dummy pixels located between at least a portion of the active pixel array and a noise source;
wherein outputs of the dummy pixels are coupled to float with respect to the active pixel array.

2. The image sensor of claim 1, wherein the image sensor is a CMOS image sensor.

3. The image sensor of claim 1, wherein the dummy pixels surround the active pixel array.

4. The image sensor of claim 3, wherein the dummy pixels constitute a ring of dummy pixels.

5. The image sensor of claim 4, wherein the ring of dummy pixels has a rectangular shape.

6. The image sensor of claim 4, wherein the ring of dummy pixels is a closed ring.

7. The image sensor of claim 4, wherein the noise source includes an analog circuit, a digital circuit, or a dark reference pixel array that is outside of the ring of dummy pixels.

8. The image sensor of claim 4, further comprising a dark reference pixel array enclosed by the ring of dummy pixels.

9. The image sensor of claim 8, wherein the dark reference pixel array comprises at least one light-shielded pixel.

10. The image sensor of claim 1, wherein the active pixel array comprises:
a photodiode;
a transfer gate configured to transfer a light signal of the photodiode;
a reset gate configured to reset the photodiode to a reset reference voltage;
a source follower configured to buffer the light signal; and
a selector configured to enable an output of the source follower to be read through a column bus.

11. The image sensor of claim 1, wherein the dummy pixel comprises:
a photodiode;
a transfer gate configured to continuously transfer a noise signal of the photodiode;
a reset gate configured to continuously reset the photodiode;
a source follower configured to buffer the noise signal; and
a selector with a floating output.

12. The image sensor of claim 11, wherein the transfer gate and the reset gate of the dummy pixel are always turned on.

13. An image sensor comprising:
an imaging pixel array having imaging pixels;
a ring of non-imaging pixels surrounding the imaging pixel array; and
a noise source external to the ring of non-imaging pixels;
wherein unwanted charge originated from the noise source is drained away by the non-imaging pixels.

14. The image sensor of claim 13, wherein outputs of the non-imaging pixels are floating with respect to the imaging pixel array.

15. The image sensor of claim 13, wherein the image sensor is a CMOS image sensor.

16. The image sensor of claim 13, wherein the ring of non-imaging pixels has a rectangular shape.

17. The image sensor of claim 13, wherein the ring of non-imaging pixels is a closed ring.

18. The image sensor of claim 13, wherein the noise source includes one or more of an analog circuit, a digital circuit and/or a dark reference pixel array.

19. The image sensor of claim 13, further comprising a dark reference pixel array enclosed by the ring of non-imaging pixels.

20. The image sensor of claim 19, wherein the dark reference pixel array comprises one or more light-shielded pixels.

21. The image sensor of claim 13, wherein the imaging pixel comprises:
a photodiode;
a transfer gate configured to transfer a light signal of the photodiode;
a reset gate configured to reset the photodiode to a reset reference voltage;
a source follower configured to buffer the light signal; and
a selector configured to enable an output of the source follower to be read through a column bus.

22. The image sensor of claim 13, wherein the non-imaging pixel comprises:
a photodiode;
a transfer gate configured to continuously transfer a noise signal of the photodiode;
a reset gate configured to continuously reset the photodiode;
a source follower configured to buffer the noise signal; and
a selector with a floating output.

23. The image sensor of claim 22, wherein the transfer gate and the reset gate of the non-imaging pixel are always turned on.
